(19) United States
(12) Patent Application Publication
(10) Pub. No.: US 2020/0091549 A1
(43) Pub. Date: Mar. 19, 2020

(54) METHOD FOR PRODUCING A LITHIUM-ION CELL

(71) Applicant: VOLKSWAGEN AKTIENGESELLSCHAFT, Wolfsburg (DE)

(72) Inventors: Enrica JOCHLER, Calberlah (Allerbüttel) (DE); Dominik Alexander WEBER, Braunschweig (DE)

(73) Assignee: VOLKSWAGEN AKTIENGESELLSCHAFT, Wolfsburg (DE)

(21) Appl. No.: 16/561,616

(22) Filed: Sep. 5, 2019

(30) Foreign Application Priority Data
Sep. 18, 2018 (DE) 10 2018 215 808.8

(51) Int. Cl. H01M 10/0525; H01M 4/66; H01M 10/0565; H01M 4/04

(52) U.S. Cl. CPC H01M 10/0525; H01M 4/661; H01M 2004/027; H01M 4/667; H01M 4/0404; H01M 10/0565

(57) ABSTRACT

The invention relates to a method for producing a lithium-ion cell in which a polymer layer is applied to an aluminum foil, a nickel-containing cathode slurry is applied to the aluminum foil, the polymer layer is chemically and mechanically stable during this electrode production, and the moist cathode slurry is dried. The method is improved particularly in terms of cost and environmental protection in that water is used as the solvent for the cathode slurry and that the polymer layer is dissolved during the formation of the lithium-ion cell.

### FIELD OF THE INVENTION

The invention relates to a method for producing a lithium-ion cell.

### BACKGROUND OF THE INVENTION

During the manufacture of a cathode and an anode, the material for the anode and cathode is mixed with additives such as binders and conductive additives to form a thin paste. This paste is called “slurry” in English. An aluminum foil for the cathode and a copper foil for the anode are then conveyed to a coating system, which applies the cathode slurry and the anode slurry, namely the corresponding material, to the foil. Once the foils have now been provided on both sides with the cathode slurry or anode slurry and the cathode slurry and anode slurry have dried, so-called calendering is performed in which the now-dried active material is compressed on the foils. The coating films are compressed for this purpose, for example between two rollers.

DE 10 2014 222 664 A1 discloses a method for producing the cathode and/or the anode of a lithium-ion cell. Here, an active material powder, a powdered electrically conductive additive and an electrode binder are mixed using a carrier solvent to form a coating composition. The coating composition is applied to an electrically conductive foil, and the solvent is removed. A conductive additive has been subjected to surface oxidation prior to mixing. N-methyl-2-pyrrolidone, N-methyl-2-pyrrolidone, or acetone or water can be used as the solvent. Polyvinylidene fluoride (PVDF) or PVDF-hexafluoropropene (HFP) minus copolymer can be used as binder. A powdered binder (e.g., PVDF) is dissolved in the organic solvent. The binder solution is mixed with cathode active material and conductive additives such as graphite or conductive carbon black until a homogeneous cathode slurry is formed. Using doctor blade or spray methods, the slurry is applied to a carrier foil, for example aluminum, and dried in a drying oven, for example for 2 hours at 120° C., until the liquid solvent components escape from the coating. The dried electrode is compacted and set up against a corresponding anode together with a separating layer and an electrolyte to form a lithium-ion battery cell.

The use of such organic solvents as N-methylpyrrolidone (NMP) is not optimal. Drawbacks of this method include the fact that the solvent NMP is teratogenic and detrimental to fertility. A corresponding maximum occupational exposure must be observed, and suitable respiratory protective measures are required during processing. In addition, NMP must be recycled from the hot drying gas when the wet electrodes are dried. A cost-intensive solvent recycling system is required. NMP is flammable, which is why the drying plant must be explosion-proof.

The object is therefore to find an alternative solvent that is not harmful to health and is favorable in terms of both its acquisition and system design. Water-based slurry production is one possible solution.

However, the processing of a slurry with cathode active material, especially nickel-containing cathode material, particularly the cathode active material with the formula LiNixMnyCozO₂, where x=0.33 . . . 0.98, y=0.01 . . . 0.33, z=0.01 . . . 0.33 (abbreviated as NMC) poses a challenge. The pH of an NMC slurry is very high. Depending on the proportion of nickel in the material, the pH is between 10 for LiNi0.33CoMn0.33Co0.33O₂ and 12.3 for LiNi0.8Mn0.1Co0.1O₂. A pH in the alkaline range of >8.5 can lead to corrosion of the aluminum conductor, which results in an increase in the internal resistance. Due to the alkaline environment, it is therefore necessary to protect the aluminum conductor against corrosion.

An electrochemical cell with a nickel-coated aluminum current collector is known from U.S. Pat. No. 5,518,839 A. The electrochemical cell is embodied as a solid-state battery. The electrolyte is formed by a polymer network. A current collector comprises an etched aluminum foil that is provided with a thin coating of a metal, for example nickel, that is more resistant to corrosion than aluminum. The aluminum foil is provided with the metallic corrosion-resistant coating by means of electroplating. Alternatively, a polymeric carrier can be used to apply the metal to the aluminum layer, followed by removal of the polymer by volatilization.

A current collector is known from U.S. Pat. No. 5,578,399 A which comprises an aluminum or copper foil coated with a layer of cured polymer that is hole-free for corrosion resistance. A cured, conductive polymer layer is applied to the aluminum or copper foil. A polymer electrolyte is arranged between the anode and the cathode. A current collector having a metal layer of aluminum or copper is disposed adjacent to either the anode or cathode on a side opposite the polymer electrolyte. On a side of the metal layer opposite the cathode or the anode, the coating of the cured polymer is applied in an amount that is effective for preventing corrosion between the cathode or the anode or the metal layer. This polymer layer is conductive, pinhole-free, and adheres to the metal layer. The metal layer is coated with at least one monomer or prepolymer that can form a polymer upon curing. The polymeric coating comprises such an amount of conductive material that the coating has an electrical conductivity of at least 1 S cm⁻¹.

The publication “Ambient-Air Stable Lithiated Anode for Rechargeable Li-Ion Batteries with High Energy Density” https://pubs.acs.org/doi/10.1021/acs.nanolett.6b03655 describes a structure in which a polymer layer is applied to a lithium layer that is disposed on a copper foil. The polymer layer protects the sensitive lithium against oxygen and moisture and is chemically stable to active materials. The active materials (graphite, SiOx) are dispersed in a slurry and applied to the polymer-clad lithium in order to produce an electrode. The protective layer dissolves in the finished battery cell, and the lithium is incorporated into the structure of the graphite or silicon (LixSi or LixC), thus resulting in prelithiation. This method is only used for the anode side of a battery cell.

It is, therefore, the object of the invention to improve the method.

### SUMMARY OF THE INVENTION

This object on which the invention is based is achieved by a method for producing a lithium-ion cell as claimed.

The method relates to the production of a lithium-ion cell in which a polymer layer is applied to an aluminum foil, a nickel-containing cathode slurry is applied to the aluminum foil, the polymer layer is chemically and mechanically stable during this electrode production, and the moist cathode slurry is dried. It is especially advantageous according to the invention for water to be used as the solvent for the cathode slurry. The use of water as a solvent in cathode slurry production has the advantage of reducing costs. This applies both to investment costs and operating costs. Explosion-proof solvent recycling systems are eliminated if no organic solvents such as N-methyl-2-pyrrolidone are used. Water is cheaper than N-methyl-2-pyrrolidone. Water is environmentally friendly and not harmful to health in comparison to N-methyl-2-pyrrolidone. The method is easy to carry out, because the polymer layer is dissolved during the formation of the lithium-ion battery cell. “Formation” refers to the first time the battery is passed through a charge-discharge sequence and takes place as part of the manufacturing process in special systems at the plant. Formation takes place after the mechanical production of the battery.

If the polymer layer is dissolved due to its chemical instability in relation to the electrolyte of the battery, the need to use additional substances is eliminated. The polymer layer dissolves during the initial charging of the lithium-ion battery cell.

An anhydrous solution in which a lithium salt is dissolved in an organic solvent mixture can be used as electrolyte. The electrolyte establishes the lithium ion transport between the electrodes. The conductive salt can be present in various concentrations, e.g., from 1 to 5 mol. Examples of conductive salts include lithium hexafluorophosphate (LiPF₆) and lithium tetrafluoroborate (LiBF₄). Solvent requirements are good solvency, low melting point, high flash point, and high boiling point. One solvent alone does not meet these requirements, which is why a mixture of at least two solvents is usually used. Carbonates in particular are used as solvents. An electrolyte in which 1 mol of LiPF₆ is dissolved in EC:DMC:DEC in the ratio of 1:1:1 can be particularly used as the electrolyte.

Particularly with regard to applications in the automotive sector, it is advantageous for the cathode slurry to have a cathode active material with the formula LiNixMnyCozO₂, where x=0.33 to 0.98, y=0.01 to 0.33, z=0.01 to 0.33. These cathode active materials have been found to be advantageous in the automotive industry. The lithium-ion cell can be used in particular as part of a traction battery of a motor vehicle.

An easy-to-carry-out process is achieved by virtue of the fact that the application of the layer of polymer coating is performed using a doctor blade or jet application method with a liquid paste.

Another method for applying a uniform and correspondingly thin polymer layer is achieved by applying the layer of polymer coating by means of spin coating. Spin coating can also be referred to as rotary coating. A liquid polymer solution is applied to the aluminum foil in the vicinity of a rotation axis. The aluminum foil is rotated about the rotation axis. The propagation of the polymer solution on the aluminum foil takes place as a function of the viscosity of the polymer solution and the speed of rotation.

Preferably, the coating is applied such that the polymer layer has a thickness of between 1 nm and 50 μm. On the one hand, protection from corrosion is achieved in this way, and, on the other hand, it is ensured that the polymer layer dissolves during the formation of the cell.

Preferred materials for the polymer layer are PMMA (polymethyl methacrylate), PAA (polyacrylic acid), PAMA (polyacryl methylacrylate), or PPC (polypropylene carbonate).

The physical adhesion of the coating to the conductor—here to the aluminum foil—is also enhanced by a calendering step in which the dry cathode coating and the polymer layer are pressed onto the aluminum foil.

### BRIEF DESCRIPTION OF THE DRAWINGS

There are now a variety of ways to advantageously configure and develop the method according to the invention. Reference is made firstly to the claims that are subordinated to claim 1. In the following, a preferred embodiment of the invention may be explained in more detail with reference to the drawings and the associated description. In the drawing:

FIG. 1 shows an electrode of a lithium-ion battery cell before an initial charge,

FIG. 2 shows a sectional view of a lithium-ion battery cell before an initial charge,

FIG. 3 shows a section through the battery cell after an initial charge, with a polymer layer having been dissolved.

### DETAILED DESCRIPTION OF THE INVENTION

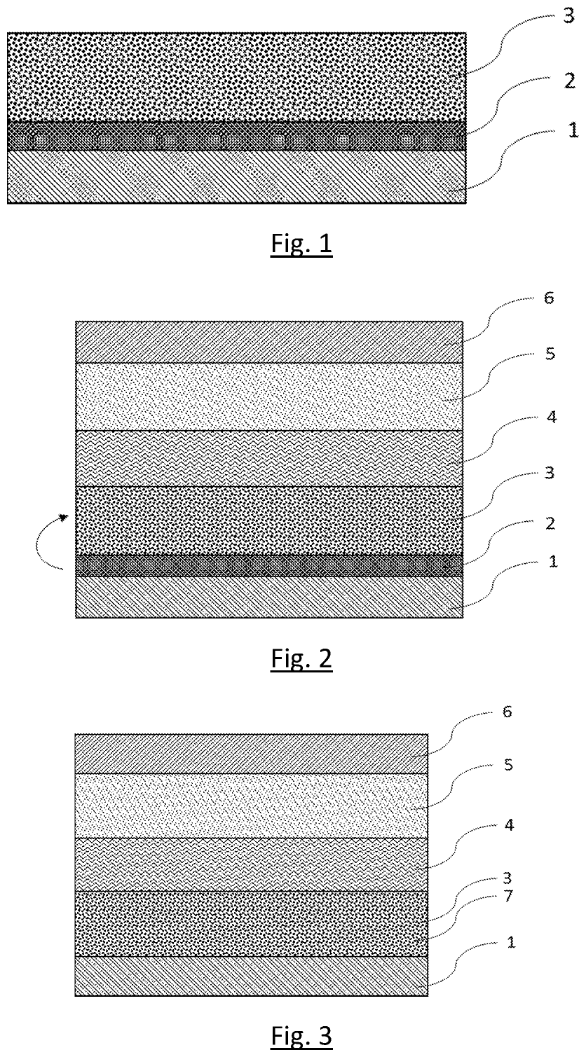

FIG. 1 shows an electrode of a lithium-ion cell with an aluminum foil 1 that is coated with a polymer layer 2. A cathode slurry 3 has been applied to the polymer layer 2 and dried. The application of the coating can be carried out by means of a doctor blade or jet application method with a liquid paste. Furthermore, a coating can be produced by means of spin coating or a rotary coating method. The polymer coating 2 can be from a few nm to a several μm thick. PMMA (polymethyl methacrylate), PAA (polyacrylic acid), PAMA (polyacryl methylacrylate) or PPC (polypropylene carbonate) can be used as the polymer.

A nickel-containing cathode slurry 3 is applied to the coated aluminum foil 1. In particular, it is possible to apply water-based cathode active material of the formula LiNixMnyCozO₂, where x=0.33 to 0.98, y=0.01 to 0.33, z=0.01 to 0.33. This cathode active material will be abbreviated as NMC below. The cathode active material uses a water-based solvent. This water-based cathode active material can be applied by a doctor blade or jet application method. This polymer coating 2 on the aluminum foil 1 protects against corrosion of the aluminum foil 1 in the alkaline slurry medium. The polymer layer 2 is stable against the NMC slurry 3 at a pH of 11. The wet electrode is dried, particularly in a drying oven, so that the liquid constituents, namely here the water in particular, can escape. During this method step of electrode fabrication, the polymer layer 2 is stable. The aluminum foil 1 serves as a conductor. The aluminum foil 1, the polymer layer 2, and the cathode coating 3 form the electrode, namely the cathode of the lithium-ion cell.

FIGS. 2 and 3 show corresponding lithium-ion battery cells. Several layers are shown here, namely the aluminum foil 1, the polymer layer 2 (FIG. 2 only), the cathode layer 3, an electrolyte 4, an anode layer 5, and a copper foil 6.

During the contact with the electrolyte 4 or during the formation, the polymer layer 2 now dissolves (see FIG. 3). In particular, the polymer layer 2 is dissolved on the aluminum foil 1 during the initial charging of the lithium-ion battery cell. The dissolved polymer layer 2 has no negative impact on the adhesion of the cathode coating 3 to the aluminum foil 1. The dissolved polymer components 7 may even be conducive to adhesion. The physical adhesion of the coating to the conductor—here to the aluminum foil 1—is also enhanced by a calendering step in which the dry cathode coating 3 and the polymer 2 are pressed onto the aluminum foil 1.

The polymer coating 2 is chemically and mechanically stable during the production of the electrode. The polymer coating 2 dissolves in a finished lithium-ion battery cell. After the dissolution of the polymer layer 2, the dissolved polymer components 7 are absorbed in the cathode coating matrix 3. Correspondingly dissolved polymer components 7 in the cathode coating 3 are present in FIG. 3. The dissolution can occur as a result of the chemical instability against the electrolyte 4 of the battery. The aluminum foil 1 is protected against corrosion due to the high pH in a water-based NMC-containing slurry. The NMC-containing slurry is alkaline. The use of water as a solvent for cathode slurry production saves costs, both in terms of investment and operation. Explosion-proof systems for recycling solvent are eliminated if no organic solvents such as N-methyl-2-pyrrolidone are used. Water is cheaper than N-methyl-2-pyrrolidone. As a solvent, water is environmentally friendly and not harmful to health in comparison to N-methyl-2-pyrrolidone.

The method described is suitable both for lithium-ion battery cells that are used in motor vehicles as well as in the mobile sector and in the consumer sector.

### LIST OF REFERENCE SYMBOLS

1 aluminum foil
2 polymer layer
3 cathode coating/cathode slurry
4 electrolyte
5 anode coating
6 copper roll
7 dissolved polymer components

1. A method for producing a lithium-ion cell, comprising:
applying a polymer layer to an aluminum foil, wherein the polymer layer is chemically and mechanically stable during this application,
applying a nickel-containing cathode slurry to the aluminum foil, wherein water is used as solvent for the cathode slurry, and
drying the cathode slurry,
wherein the polymer layer is dissolved during the formation of the lithium-ion cell.

2. The method as set forth in claim 1, wherein the polymer layer is dissolved due to the chemical instability against the electrolyte of the battery.

3. The method as set forth in claim 1, wherein an anhydrous solution in which a lithium salt is dissolved in an organic solvent mixture is used as the electrolyte.

4. The method as set forth in claim 1, wherein the polymer layer (is dissolved during an initial charging of the lithium-ion cell.

5. The method as set forth in claim 1, wherein the cathode slurry has a cathode active material with the formula LiNixMnyCozO2, where x=0.33 to 0.98, y=0.01 to 0.33, z=0.01 to 0.33.

6. The method as set forth in claim 1, wherein the step of applying the polymer layer is performed using a doctor blade or jet application method with a liquid paste.

7. The method as set forth in claim 1, wherein the step of applying the polymer layer is performed by means of rotary coating (spin coating).

8. The method as set forth in claim 1, wherein the polymer layer has a thickness of between 1 nm and 50 μm.

9. The method as set forth in claim 1, wherein PMMA (polymethyl methacrylate), PAA (polyacrylic acid), PAMA (polyacryl methylacrylate), or PPC (polypropylene carbonate) are used as the polymer layer.

10. The method as set forth in claim 1, further comprising calendering the dry cathode coating and the polymer layer by pressing them onto the aluminum foil.

11. The method as set forth in claim 1, wherein the lithium-ion cell is used in a traction battery of a motor vehicle.
